(19) United States
(12) Patent Application Publication
(10) Pub. No.: US 2023/0249228 A1
(43) Pub. Date: Aug. 10, 2023

(54) ELECTRONIC DEVICE

(71) Applicant: InnoLux Corporation, Miao-Li County (TW)

(72) Inventors: Ming-Han LIN, Miao-Li County (TW); Lung-Chang LIN, Miao-Li County (TW); Ping-Huang TU, Miao-Li County (TW)

(21) Appl. No.: 18/151,979

(22) Filed: Jan. 9, 2023

(30) Foreign Application Priority Data
Feb. 9, 2022 (CN) 202220329987.1

(51) Int. Cl. B08B 5/02; B08B 13/00

(52) U.S. Cl. CPC B08B 5/02; B08B 13/00

(57) ABSTRACT

An electronic device for removing a to-be-removed object on a device under test (DUT) is provided. The electronic device includes a working platform, an identification unit and a removal unit. The working platform carries the DUT. The identification unit is arranged above the working platform for acquiring position information of the to-be-removed object. The removal unit is coupled to the identification unit, and the removal unit includes a removal element. The removal element removes the to-be-removed object according to the position information. The removal element has a ring structure and a confinement space, wherein the ring structure is connected with the confinement space and the confinement space faces the working platform.

### CROSS REFERENCE TO RELATED APPLICATION

This application claims the benefits of the Chinese Patent Application Serial Number 202220329987.1, filed on Feb. 9, 2022, the subject matter of which is incorporated herein by reference.

### BACKGROUND

### 1. Field of the Disclosure

The present disclosure relates to an electronic device and, more particularly, to an electronic device capable of removing objects to be removed.

### 2. Description of Related Art

Generally, small foreign objects are prone to exist on the surface of a device under test (for example, a wafer) and, if the size of the foreign object exceeds a specific size (for example, an allowable range), the test result will be negatively affected. Therefore, these foreign objects can be regarded as objects to be removed. In the prior art, the to-be-removed object is manually removed under a microscope by using a vacuum pen. However, the manual method has many disadvantages, for example, it is not easy for the human eye to determine whether the size of the to-be-removed object exceeds the allowable range, the manual operation may misjudge, and the manual labor may consumes a lot of time and cost.

Therefore, there is a need for an electronic device to mitigate and/or obviate the above problems.

### SUMMARY

The present disclosure relates to an electronic device for removing a to-be-removed object from a device under test. The electronic device includes a working platform, an identification unit and a removal unit. The working platform is provided to carry the device under test. The identification unit is arranged above the working platform to acquire position information of the to-be-removed object. The removal unit is coupled to the identification unit, and includes a removal element for removing the to-be-removed object according to the position information. The removal element has a ring structure and a confinement space, wherein the ring structure is connected with the confinement space, and the confinement space faces the working platform.

Other novel features of the present disclosure will become more apparent from the following detailed description when taken in conjunction with the accompanying drawings.

### BRIEF DESCRIPTION OF THE DRAWINGS

FIG. 1A is a schematic diagram of the electronic device according to an embodiment of the present disclosure;

FIG. 1B is a front view of the electronic device according to the embodiment of FIG. 1A;

FIG. 1C is a top view of the electronic device according to the embodiment of FIG. 1A;

FIG. 1D is a schematic diagram of the electronic device according to another embodiment of the present disclosure;

FIG. 1E is a schematic diagram of the electronic device according to still another embodiment of the present disclosure;

FIG. 2 is a schematic diagram of a removal element according to an embodiment of the present disclosure;

FIG. 3A is a cross-sectional view of an elastic portion according to an embodiment of the present disclosure;

FIG. 3B is a front view of the elastic portion according to the embodiment of FIG. 3A;

FIG. 4A is a schematic diagram of the internal structure of the main body portion and the end portion according to the first embodiment of the present disclosure;

FIG. 4B is a bottom view of the main body portion and the end portion according to the first embodiment of the present disclosure;

FIG. 4C is a schematic diagram of the internal structure of the main body portion and the end portion according to the second embodiment of the present disclosure;

FIG. 4D is a bottom view of the main body portion and the end portion according to the second embodiment of the present disclosure;

FIG. 5A is a schematic diagram of the working platform according to an embodiment of the present disclosure;

FIG. 5B is a schematic diagram of the internal structure of the working platform according to an embodiment of the present disclosure; and

FIG. 6 is a flow chart illustrating the operation of the electronic device according to an embodiment of the present disclosure.

### DETAILED DESCRIPTION OF EMBODIMENT

The implementation of the present disclosure is illustrated by specific embodiments to enable persons skilled in the art to easily understand the other advantages and effects of the present disclosure by referring to the disclosure contained therein. The present disclosure is implemented or applied by other different, specific embodiments. Various modifications and changes can be made in accordance with different viewpoints and applications to details disclosed herein without departing from the spirit of the present disclosure.

It is noted that, in the specification and claims, unless otherwise specified, having “one” element is not limited to having a single said element, but one or more said elements may be provided.

In addition, in the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. These ordinal numbers are used only to distinguish one element with a particular name from another element with the same name.

In addition, the term “adjacent” used herein may refer to describe mutual proximity and does not necessarily mean mutual contact.

In addition, the description of “when . . . ” or “while . . . ” in the present disclosure means “now, before, or after”, etc., and is not limited to occurrence at the same time. In the present disclosure, the similar description of “disposed on” or the like refers to the corresponding positional relationship between the two components, and does not limit whether there is contact between the two components, unless specifically limited. Furthermore, when the present disclosure recites multiple effects, if the word “or” is used between the effects, it means that the effects can exist independently, but it does not exclude that multiple effects can exist at the same time.

In addition, the terms “connect” or “couple” in the specification and claims not only refer to direct connection with another component, but also indirect connection with another component, or refer to electrical connection. Besides, the electrical connection may include a direct connection, an indirect connection, or a mode in which two components communicate through radio signals.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

In addition, the technical features of different embodiments disclosed in the present disclosure may be combined to form another embodiment.

In addition, the electronic device disclosed in the present disclosure may include, for example, a wafer or wafer test workstation, a test device, a cleaning device, a foreign object removal device, a display device, a backlight device, an antenna device, a sensing device, a tiled device, a touch display, a curved display or a free shape display, but it is not limited thereto. The electronic device may include, for example, liquid crystal, light emitting diode, fluorescence, phosphor, other suitable display media, or a combination thereof, but is not limited thereto. The light emitting diode may include, for example, an organic light emitting diode (OLED), a sub-millimeter light emitting diode (mini LED), a micro light emitting diode (micro LED) or a quantum dot (QD) light emitting diode (for example, QLED, QDLED) or other suitable materials or a combination thereof, but is not limited thereto. The display device may include, for example, a tiled display device, but is not limited thereto. The antenna device may be, for example, a liquid crystal antenna, but is not limited thereto. The antenna device may include, for example, a tiled antenna device, but is not limited thereto. It should be noted that the electronic device may be a combination of the foregoing, but is not limited thereto. In addition, the appearance of the electronic device may be rectangular, circular, polygonal, a shape with curved edges, or other suitable shapes. The electronic device may have peripheral systems such as a driving system, a control system, a light source system, a shelf system, etc., to support a display device, an antenna device, or a tiled device. However, the present disclosure is not limited thereto.

For convenience of description, the term “in a direction” hereinafter may represent “substantially in the direction” or “substantially in a direction opposite to the direction”, while it is not limited thereto. In addition, there may be a deviation within about 60 degrees (≤60°) between the actual direction and the said direction, but it is not limited thereto.

For the convenience of description, the following description will be made by taking the electronic device as a foreign matter removal device, but the present disclosure is not limited thereto.

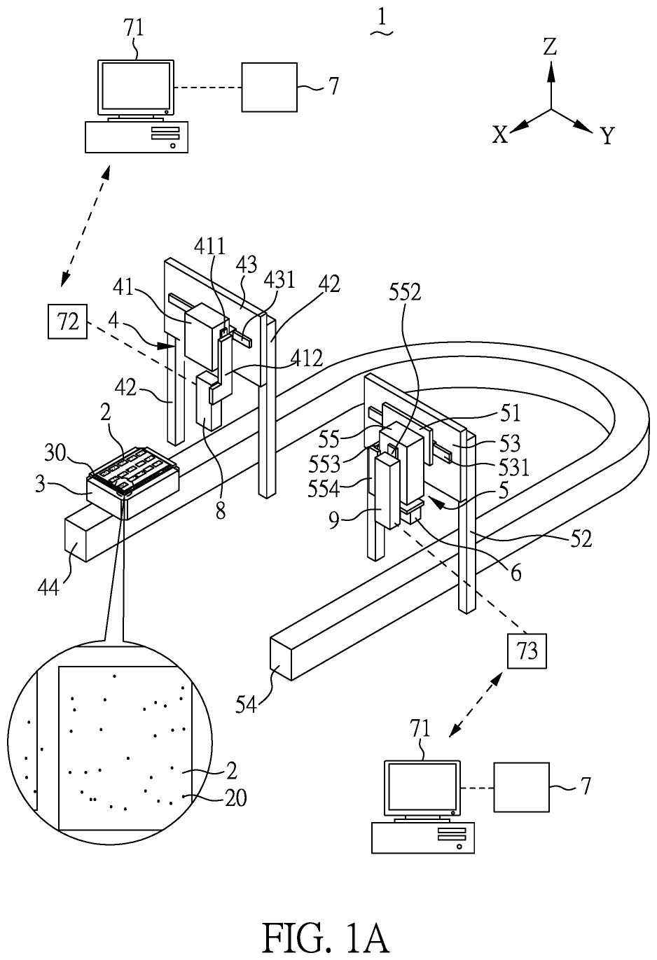

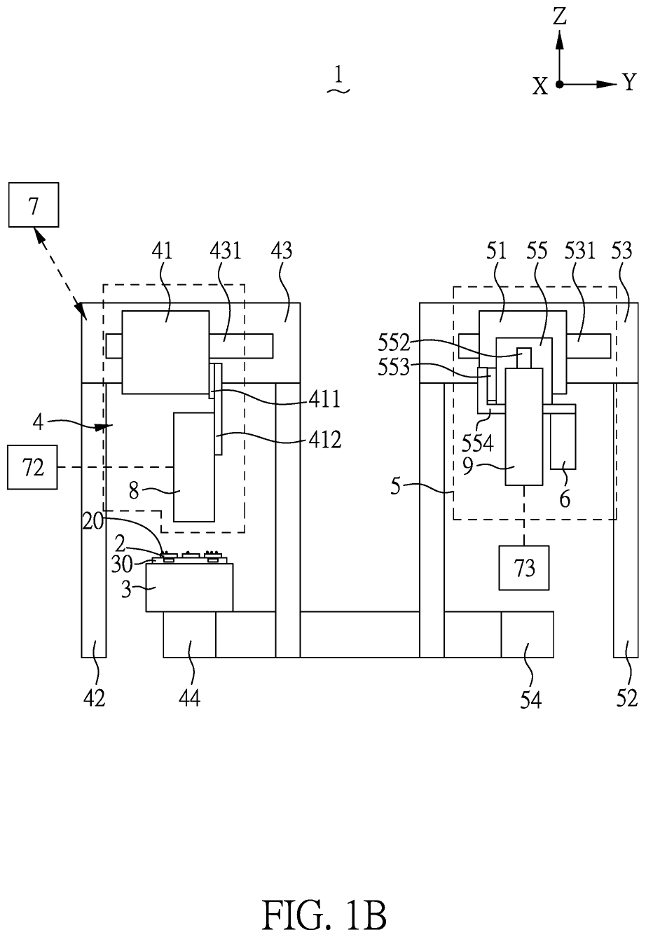

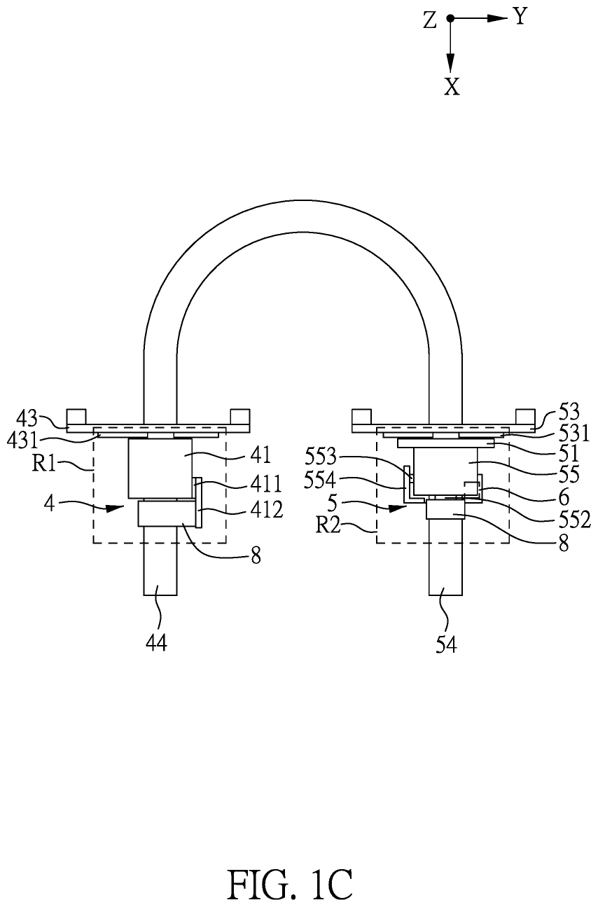

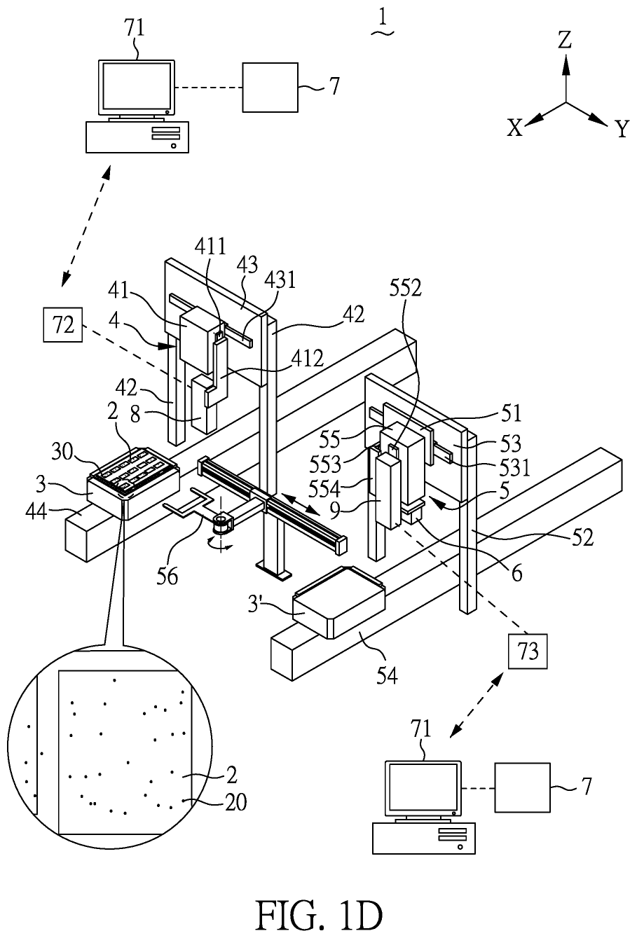

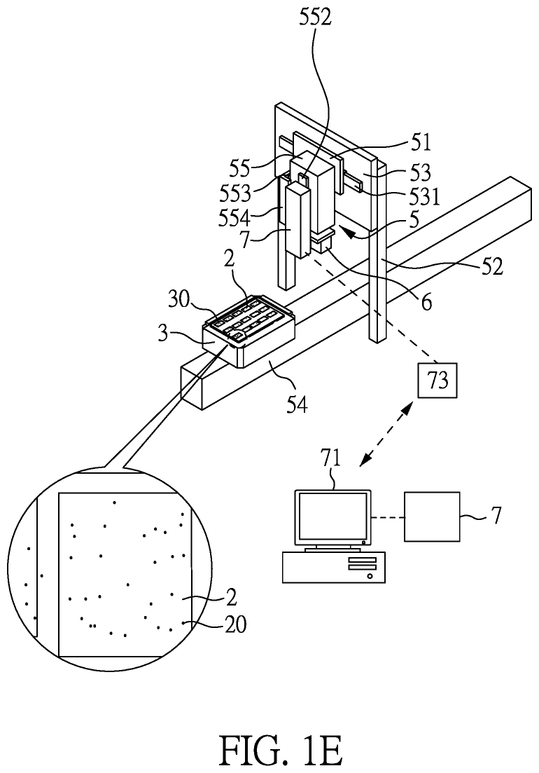

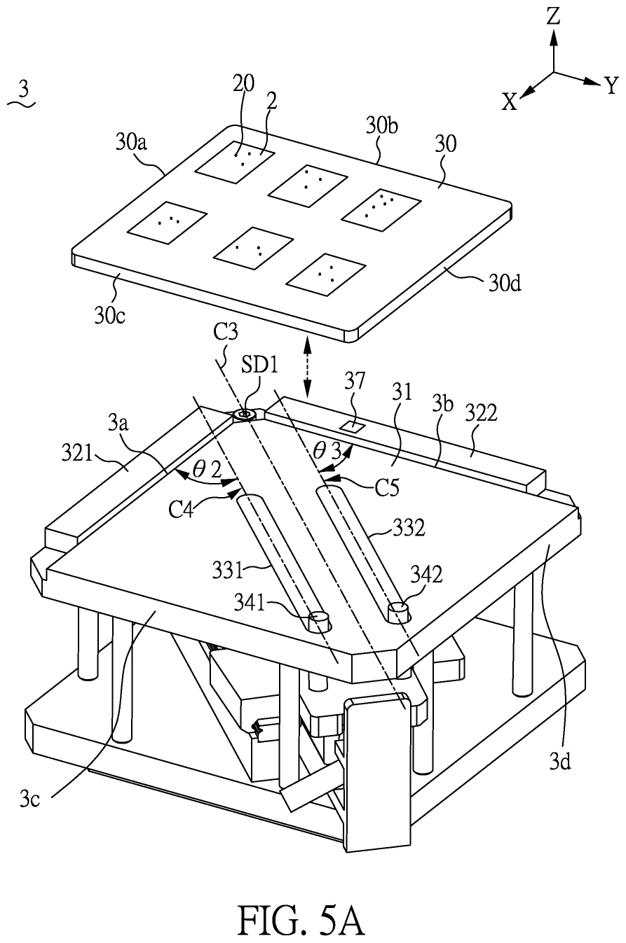

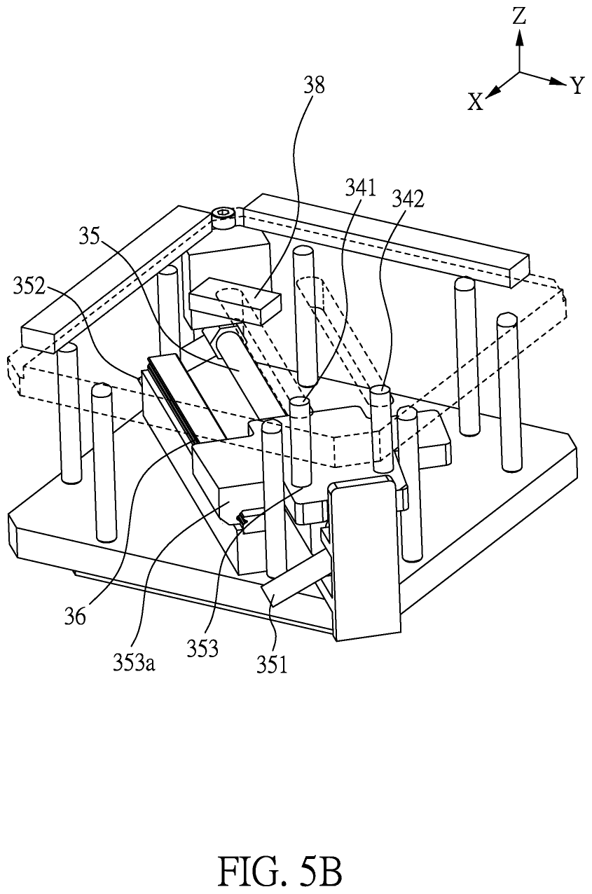

Please refer to FIGS. 1A to 1C, wherein FIG. 1A is a schematic diagram of the electronic device 1 according to an embodiment of the present disclosure, FIG. 1B is a front view of the electronic device 1 according to the embodiment of FIG. 1A, and FIG. 1C is a top view of the electronic device 1 according to the embodiment of FIG. 1A. The electronic device 1 of the present disclosure can be used to remove a to-be-removed object 20 on a device under test 2 (as shown in FIGS. 1A and 5A).

As shown in FIGS. 1A and 1B, the electronic device 1 includes a working platform 3, an identification unit 4 and a removal unit 5. The working platform 3 is provided to carry the device under test 2. The identification unit 4 is provided to acquire position information of the to-be-removed object 20 on the device under test 2. The removal unit 5 includes a removal element 6. The removal element 6 is provided to remove the to-be-removed object 20 on the device under test 2 according to the position information of the to-be-removed object 20. In addition, as shown in FIGS. 1A and 1B, in one embodiment, the electronic device 1 further includes a memory unit 7, which is coupled to the identification unit 4 and the removal unit 5, and is provided to memorize the position information of the to-be-removed object 20.

Regarding the device under test 2, in one embodiment, the device under test 2 may be, for example, one or more wafers, or one or more chips, but it is not limited thereto. In one embodiment, the material of the device under test 2 may include silicon semiconductor material, other semiconductor materials, ceramics, resin, metal, etc., but it is not limited thereto. The quantity, material, shape, structure, size, etc. of the device under test 2 are not limited. In addition, in one embodiment, the to-be-removed object 20 may be, for example, fine particles such as dust, powder, glass, etc., but it is not limited thereto. In addition, different devices under test 2 or different test items may have different tolerances for the size of the foreign objects on the device under test 2. For example, foreign objects exceeding a certain size will be regarded as pending objects 20 to be removed, while foreign objects smaller than or equal to a certain size may not be removed. However, the present disclosure is not limited thereto.

Regarding the working platform 3, as shown in FIGS. 1A and 1B, the working platform 3 may carry a tray 30 on which one or more objects to be tested 2 may be placed. In one embodiment, the working platform 3 may be placed on a first conveying track 44 and moved through the conveyance of the first conveying track 44, wherein at least part of the first conveying track 44 may be configured to extend in a first horizontal direction (e.g., X direction). In addition, in one embodiment, the first conveying track 44 may be connected with a second conveying track 54, wherein at least part of the second conveying track 54 may be configured to extend in the first horizontal direction (e.g., X direction). Therefore, the working platform 3 may be moved through the conveyance of the first conveying track 44 and the second conveying track 54. In addition, in another embodiment, the first conveying track 44 and the second conveying track 54 may be not connected (as shown in FIG. 1D), but it is not limited thereto.

Regarding the identification unit 4, as shown in FIGS. 1A, 1B and 1C, the identification unit 4 is arranged above the first conveying track 44 and the working platform 3. For example, in a vertical direction, the identification unit 4 is disposed to be higher than the first conveying track 44 and the working platform 3. In one embodiment, the identification unit 4 includes a first photographing element 8, a first vertical moving portion 412 and a first horizontal moving portion 41. The first photographing element 8 and the first horizontal moving portion 41 are connected in the vertical direction through the first vertical moving portion 412. The first vertical moving portion 412 may be arranged on a first vertical sliding rail 411 of the first horizontal moving portion 41, and the first photographing element 8 is connected with the first horizontal moving portion 41. It is noted that the “vertical direction” herein may be defined as a normal direction (e.g., Z direction) of the working platform 3 when the working platform 3 is placed flat on a plane, wherein the vertical direction (e.g., Z direction) may be orthogonal to the first horizontal direction (e.g., X direction), but it is not limited thereto. In addition, as shown in FIG. 1B, the photographing direction of the first photographing element 8 may be set to face the working platform 3 or the first conveying track 44 (if the working platform 3 moves to other places). For example, in the vertical direction (e.g., Z direction), the lens (not shown) of the first photographing element 8 faces the working platform 3 (or the first conveying track 44), and there may be an interval between the lens of the first photographing element 8 and the working platform 3 (or the first conveying track 44). In addition, the first photographing element 8 may overlap with part of the working platform 3 (or the first conveying track 44), but it is not limited thereto. The first photographing element 8 is provided to obtain images of the object under test 2 and the to-be-removed object 20 on the working platform 3.

In addition, in one embodiment, the first photographing element 8 may be provided with a first processing unit 72 for analyzing the images of the device under test 2 and the to-be-removed object so as to acquire the position information of the to-be-removed object 20, wherein the first processing unit 72 may be, for example, a processor, but it is not limited thereto. In another embodiment, the first processing unit 72 may also be arranged outside the first photographing element 8, for example, may be arranged in other positions of the identification unit 4, or may be arranged in an external computer or cloud server, while it is not limited thereto. In addition, the first photographing element 8 may be coupled with the memory unit 7, for example, the first processing unit 72 may be coupled with the memory unit 7 to provide the position information to the memory unit 7. The term “couple” herein includes aspects such as direct connection, indirect connection, electrical connection, detachable connection, fixed connection or capability of signal transmission therebetween, while it is not limited thereto.

In one embodiment, the first photographing element 8 may include one or more lenses (not shown), wherein the lens of the first photographing element 8 may include a charge-coupled device (CCD) or a complementary metal oxide semiconductor (CMOS), but it not limited thereto. In addition, in one embodiment, the identification unit 4 may also have a plurality of first photographing elements 8 (not shown) at the same time, but it is not limited thereto.

Moreover, as shown in FIGS. 1A and 1B, the first horizontal moving portion 41 may be configured to be connected to a hanging portion 43 of a first fixing base 42. In one embodiment, the hanging portion 43 is provided with a first sliding rail structure 431 extending along a second horizontal direction (e.g., Y direction), and the first horizontal moving portion 41 may be moved through the first sliding rail structure 431 in the second horizontal direction (e.g., Y direction), and drives the first photographing element 8 to move, wherein the second horizontal direction (e.g., Y direction) may be, for example, orthogonal to the vertical direction (e.g., Z direction), and the second horizontal direction (e.g., Y direction) is different from the first horizontal direction (e.g., X direction). In one embodiment, the vertical direction (e.g., Z direction), the first horizontal direction (e.g., X direction) and the second horizontal direction (e.g., Y direction) may be orthogonal to each other, but it is not limited thereto. In addition, the first horizontal moving portion 41 may be provided with a first vertical sliding rail 411 extending along the vertical direction (e.g., Z direction), and the first vertical moving portion 412 may be arranged on the first vertical sliding rail 411, so that the first vertical moving portion 412 may move in the vertical direction (e.g., Z direction) relative to the first horizontal moving portion 41, and drives the first photographing element 8 to move in the vertical direction (e.g., Z direction). Therefore, with the first horizontal moving portion 41 that moves along the second horizontal direction (e.g., moves forward or backward along Y direction), the working platform 3 that moves along the first horizontal direction (e.g., moves forward or backward along X direction), and the vertical moving portion 412 that moves along the vertical direction (e.g., moves up or down along Z direction), the identification unit 4 may obtain the images of different positions on the platform 3, on which the first processing unit 72 performs image recognition to acquire the position information of the to-be-removed object 20.

Regarding the removal unit 5, as shown in FIGS. 1A, 1B and 1C, in one embodiment, the removal unit 5 is arranged above the second conveying track 54, for example, the removal unit 5 is disposed to be higher than the second conveying track 54 in the vertical direction (e.g., Z direction). When the first conveying track 44 and the second conveying track 54 are connected, the electronic device 1 may be provided with a single working platform 3 and the single working platform 3 may move between location of the identification unit 4 and location of the removal unit 5 through the first conveying track 44 and the second conveying track 54, wherein “location of the identification unit 4” may be, for example, a projection position R1 of the identification unit 4 in the vertical direction (i.e., the normal direction of the identification unit 4, for example, Z direction), as shown in FIG. 1C. In addition, “location of the removal unit 5” may be, for example, a projection position R2 of the removal unit 5 in the vertical direction (e.g., Z direction), as shown in FIG. 1C, but the present disclosure is not limited thereto.

In addition, as shown in FIGS. 1A, 1B and 1C, the removal unit 5 may further includes a second horizontal moving portion 51, a connecting portion 55, a second vertical moving portion 554 and a second photographing element 9, and the connecting portion 55 may be provided with a second vertical sliding rail 552 and a third vertical sliding rail 553 respectively extending along the vertical direction (e.g., Z direction), wherein the connecting portion 55 is connected with the second horizontal moving portion 51, the second photographing element 9 may be arranged on the second vertical sliding rail 552 and connected to the connecting portion 55, the second vertical moving portion 554 may be arranged on the third vertical sliding rail 553 and connected to the connecting portion 55, and the removal element 6 may be connected to the second vertical moving portion 554 in the vertical direction (e.g., Z direction), but it is not limited thereto. In addition, the photographing direction of the second photographing element 9 may be toward the working platform 3 or the second conveying track 54. For example, in the vertical direction (e.g., Z direction), the lens (not shown) of the second photographing element 9 faces the working platform 3 (or the first conveying track 44), and there may be an interval between the lens of the second photographing element 9 and the working platform 3 (or the first conveying track 44). Besides, the second photographing element 9 may overlap with part of the working platform 3 (or the first conveying track 44), but it is not limited thereto. The second photographing element 9 is provided to acquire images of the device under test 2 and the to-be-removed object 20. In addition, in one embodiment, a second processing unit 73 may be arranged inside the removal element 6 or the second photographing element 9, wherein the second processing unit 73 may be, for example, a processor, but it is not limited thereto. In another embodiment, the second processing unit 73 may be arranged outside the second photographing element 9, for example, in other positions of the removal unit 5, or in an external computer or cloud server, while it is not limited to this. In addition, the removal element 6 or the second photographing element 9 may be coupled to the memory unit 7, for example, the second processing unit 73 may be coupled to the memory unit 7, but it is not limited thereto. In addition, in one embodiment, the removal element 6 may remove the to-be-removed object 20 by blowing the surface of the device under test 2, but it is not limited thereto.

In one embodiment, the second photographing element 9 may include one or more lenses (not shown), wherein the lens may include a charge coupled device (CCD) or a complementary metal oxide semiconductor (CMOS), while it is not limited thereto. In addition, in one embodiment, the removal unit 5 may be provided with a plurality of second photographing elements 9 at the same time, but it is not limited thereto.

Moreover, as shown in FIGS. 1A and 1B, the second horizontal moving portion 51 of the removal unit 5 may be configured to be connected to a hanging portion 53 of a second fixing base 52. In one embodiment, the hanging portion 53 is provided with a second sliding rail structure 531 extending along the second horizontal direction (e.g., Y direction), and the second horizontal moving portion 51 may be arranged on the second sliding rail structure 531. In one embodiment, the second horizontal moving portion 51 may move in the second horizontal direction (e.g., Y direction) by the second sliding rail structure 531, and drives the second vertical moving portion 554, the removal element 6 and the second photographing element 9 to move in the second horizontal direction (e.g., Y direction) through the connecting portion 55. Therefore, with the second horizontal moving portion 51 of the removal unit 5 that moves (forward or backward) along the second horizontal direction (e.g., Y direction), and the working platform 3 that moves (forward or backward) along the first horizontal direction (e.g., X direction), the removal unit 5 may remove the objects to be removed 20 in different positions.

In addition, as shown in FIGS. 1A and 1B, in one embodiment, the second photographing element 9 may move in the vertical direction (e.g., Z direction) by the second vertical sliding rail 552. In one embodiment, the second vertical moving portion 554 may move in the vertical direction (e.g., Z direction) by the third vertical sliding rail 553, and drives the removal element 6 to move in the vertical direction (e.g., Z direction). Therefore, with the removal element 6 and the second photographing element 9 that can move up and down along the vertical direction (e.g., Z direction) to approach or contact, or to be separated from the device under test 2 on the working platform 3, the removal unit 5 may remove the objects to be removed 20 at different positions.

Regarding the memory unit 7, in one embodiment, the type of the memory unit 7 may include a memory, a hard disk, a register, etc., while it is not limited thereto. In one embodiment, the memory unit 7 may be arranged inside the electronic device 1. However, in another embodiment, the memory unit 7 may be arranged outside the electronic device 1, for example, in an external device 71, wherein the external device 71 may be, for example, a computer, but it is not limited thereto. In addition, in one embodiment, the memory unit 7 may be a screen for memorizing, displaying and/or transmitting position information. It is noted that the aspect of the memory unit 7 of the present disclosure is not limited to the above description and, as long as it is reasonable, any element capable of memorizing and transmitting position information may be used as the memory unit 7 of the present disclosure.

The electronic device 1 may also have different implementation aspects. FIG. 1D is a schematic diagram of the electronic device 1 according to another embodiment of the present disclosure, and please also refer to FIG. 1A. Compared with the embodiment of FIG. 1A, the first conveying track 44 is not connected to the second conveying track 54 in the embodiment of FIG. 1D. At this moment, another working platform 3′ may be placed on the second conveying track 54, and a robotic arm 56 may be arranged between the first conveying track 44 and the second conveying track 54 to move the tray 30 from the working platform 3 on the first conveying track 44 to the another working platform 3′ on the second conveying track 54. It is noted that the robotic arm 56 may be replaced with other equipment having the function of moving objects, such as an automated guided vehicle (AGV) and the like. The present disclosure is not limited thereto.

In addition, FIG. 1E is a schematic diagram of the electronic device 1 according to still another embodiment of the present disclosure, and please refer to FIGS. 1A and 1D. Compared with the embodiment of FIG. 1A and the embodiment of FIG. 1D, the identification unit 4 and the removal unit 5 may be integrated together in the embodiment of FIG. 1E, wherein the identification unit 4 and the removal unit 5 may share the first photographing element 8; that is, the first photographing element 8 may also be used as the second photographing element 9. However, the present disclosure is not limited thereto.

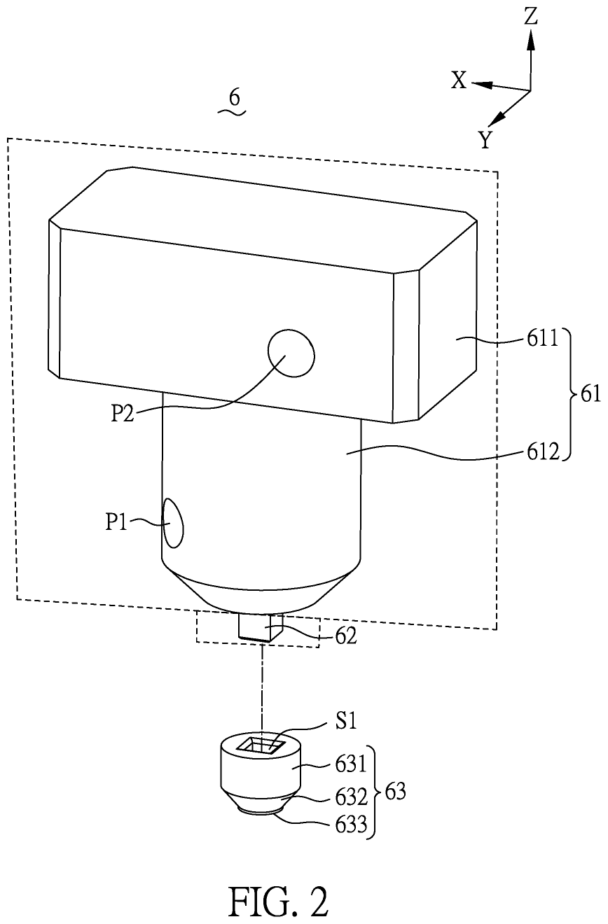

Next, the detailed features of the removal element 6 will be described. FIG. 2 is a schematic diagram of the removal element 6 according to an embodiment of the present disclosure, and please also refer to FIGS. 1A to 1E as a reference.

As shown in FIG. 2, the removal element 6 includes a main body portion 61, an end portion 62 and an elastic portion 63, wherein the elastic portion 63 is provided to be coupled with the end portion 62 (e.g., detachably connected), and thus the end portion 62 may be regarded as a portion coupled with the elastic portion 63. In one embodiment, the main body portion 61 has a base seat 611 and an extension portion 612. As shown in FIG. 1A and FIG. 2, the base seat 611 may be used to be connected with the second vertical moving portion 554, wherein the connection may be, for example, snapping, locking, pivoting, etc., but it is not limited thereto. The extension portion 612 is connected between the base seat 611 and the end portion 62. In one embodiment, the projected area of the base seat 611 in the vertical direction (e.g., Z direction) may be larger than the projected area of the extension portion 612 in the vertical direction (e.g., Z direction), and the extension portion 612 in the vertical direction (e.g., Z direction) may be larger than the projected area of the end portion 62 in the vertical direction (e.g., Z direction), but it is not limited thereto. In one embodiment, the projected areas of the base seat 611, the extension portion 612 and the end portion 62 in the vertical direction (e.g., Z direction) may overlap, but it is not limited thereto.

Moreover, as shown in FIG. 2, in one embodiment, the elastic portion 63 has a joint portion 631, a constriction portion 632 and a ring structure 633. The constriction portion 632 is connected between the joint portion 631 and the ring structure 633 and, in the vertical direction (e.g., Z direction), one end of the constriction portion 632 adjacent to the joint portion 631 gradually narrows toward the other end adjacent to the ring structure 633. In addition, the joint portion 631 has a joint space S1 corresponding to the end portion 62. For example, the size of the joint space S1 may be similar to the size of the end portion 62, so that at least part of the end portion 62 may be inserted into the joint space S1 for being engaged therewith. In one embodiment, the elastic portion 63 and the end portion 62 are detachably jointed, but it is not limited thereto. In addition, the main body portion 61 has a gas extraction through hole P1 that may be arranged on the base seat 611 or the extension portion 612. In addition, in one embodiment, the main body portion 61 may be provided with a gas inlet through hole P2 arranged on the base seat 611 or the extension portion 612.

In one embodiment, the shape of the joint space S1 of the end portion 62 and the elastic portion 63 may correspond to each other, such as a rectangular body, a cylindrical body or the like, but it is not limited thereto. In one embodiment, the material of the elastic portion 63 may include rubber, synthetic rubber, silicone, conductive silicone, fluorine rubber, and fluorine silicone rubber, while it is not limited thereto.

With the arrangement of the elastic portion 63, when the removal element 6 is in contact with the device under test 2, the elastic portion 63 may buffer the collision between the removal element 6 and the device under test 2, thereby avoiding damage to the device under test 2. However, the present disclosure is not limited thereto.

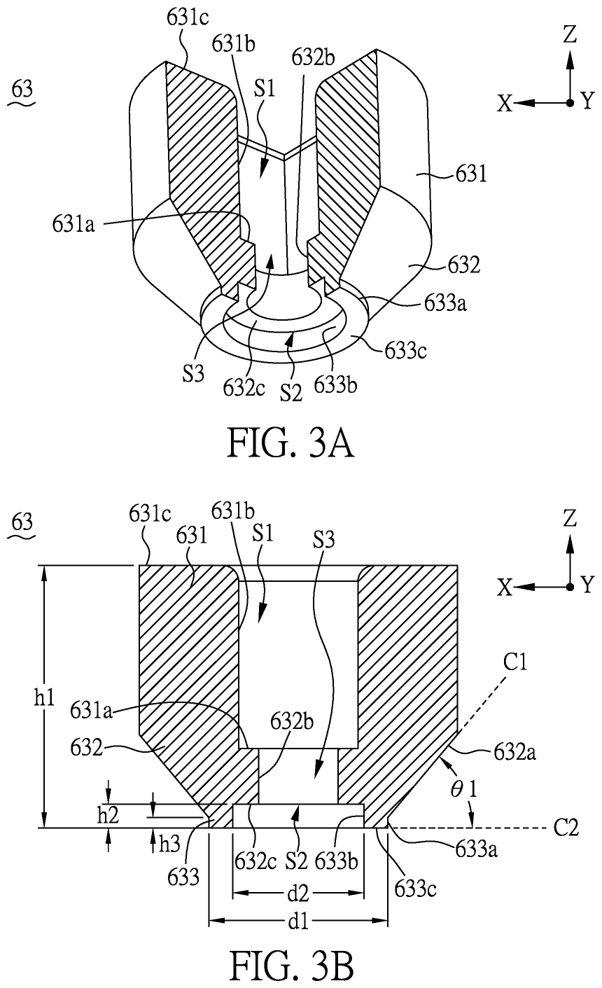

Next, the detailed features of the elastic portion 63 will be described in detail. FIG. 3A is a partial cross-sectional view of the elastic portion according to an embodiment of the present disclosure, FIG. 3B is a front view of the elastic portion according to the embodiment of FIG. 3A, and please also refer to FIGS. 1A to 2 for reference.

As shown in FIGS. 3A and 3B, there is a hollow portion provided inside the elastic portion 63. The hollow portion of the elastic portion 63 may include a joint space S1, a confinement space S2 and a passage space S3, wherein the passage space S3 is connected between the joint space S1 and the confinement space S2. As shown in FIGS. 1A, 3A and 3B, the confinement space S2 may face the second conveying track 54, wherein the term “face” may refer to, for example, in the vertical direction (e.g., Z direction), the confinement space S2 being closer to the device under test 2 or the second conveying track 54 than the joint space S1 and the passage space S3, so that, when the working platform 3 is placed on the second conveying track 54, the confinement space S2 will face the working platform 3 and the device under test 2 on the working platform 3.

Regarding the confinement space S2, in one embodiment, the ring structure 633 has an outer peripheral wall 633a, an inner peripheral wall 633b and an outer surface 633c, the constriction portion 632 has an inner wall 632b and an annular inner surface 632c, and the joint portion 631 has a first inner wall 631a, a second inner wall 631b and a joint top portion 631c. The inner peripheral wall 633b of the ring structure 633 is connected to the confinement space S2. For example, in the vertical direction (e.g., inner peripheral wall 633b of the ring structure 633 extends from the position adjacent to the outer surface 633c toward the annular inner surface 632c of the constriction portion 632, thereby forming the confinement space S2, and the inner wall 632b of the constriction portion 632 extends from the position adjacent to the annular inner surface 632c toward the first inner wall 631a, thereby forming the passage space S3. In addition, on a projection plane of the second horizontal direction (e.g., Y direction), the first inner wall 631b of the joint portion 631 may extend to the second inner wall 631b of the joint portion 631 along the first horizontal direction (e.g., X direction), and the second inner wall 631b of the joint portion 631 may extend to the joint top portion 631c along the vertical direction (e.g., Z direction), thereby forming the joint space S1.

In one embodiment, the projected area of the joint space S1 in the vertical direction (e.g., Z direction) is larger than the projected area of the passage space S3 in the vertical direction (e.g., Z direction). In one embodiment, the projected area of the confinement space S2 in the vertical direction (e.g., Z direction) is larger than the projected area of the passage space S3 in the vertical direction (e.g., Z direction). However, the present disclosure is not limited thereto.

Moreover, as shown in FIG. 3B, in the vertical direction (e.g., Z direction), the elastic portion 63 has a first height h1, the confinement space S2 has a second height h2, and the outer peripheral wall 633a of the ring structure 633 has a third height h3, wherein, on the projection plane of the second horizontal direction (e.g., Y direction), the first height h1 may be defined as the distance between the outer surface 633c of the ring structure 633 and the joint top portion 631c, the second height h2 may be defined as the distance between the outer surface 633c of the ring structure 633 and the annular inner surface 632c of the constriction portion 632, and the third height h3 may be defined as the extension height of the outer peripheral wall 633a of the ring structure 633 in the vertical direction (e.g., Z direction). In one embodiment, the second height h2 may be between 0.1 millimeter (mm) and 1 mm (i.e., 0.2 mm≤h2≤0.4 mm), and may also be between 0.25 mm and 0.35 mm (i.e., 0.25 mm≤h2≤0.35 mm), but it is not limited thereto. In one embodiment, the third height h3 may be between 0.05 mm and 0.2 mm (i.e., 0.05 mm≤h3≤0.2 mm), and may also be between 0.1 mm and 0.15 mm (i.e., 0.1 mm≤h3≤0.15 mm), but it is not limited thereto. With any of the aforementioned configurations, the ability of the removal element 6 to remove the to-be-removed object 20 can be improved.

In addition, in a horizontal direction (e.g., X direction) orthogonal to the vertical direction (e.g., Z direction), the ring structure 633 has a first width d1, wherein the first width d1 may be regarded as an outer diameter of the projection of the ring structure 633 in the vertical direction (e.g., Z direction), and the confinement space S2 has a second width d2, wherein the second width d2 may be regarded as an inner diameter of the projection of the ring structure 633 in the vertical direction (e.g., Z direction). In one embodiment, the first width d1 may be between 3 mm and 6 mm (i.e., 3 mm≤d1≤6 mm), and may also be between 4 mm and 5 mm (i.e., 4 mm≤d1≤5 mm), but it is not limited thereto. In one embodiment, the second width d2 may be between 2 mm and 5 mm (i.e., 2 mm≤d2≤5 mm), and may also be between 3 mm and 4 mm (i.e., 3 mm≤d2≤4 mm), but it is not limited thereto. With any of the aforementioned configurations, the ability of the removal element 6 to remove the to-be-removed object 20 can be improved.

In one embodiment, the ratio of the first height h1 to the second width d2 may be between 0.5 and 2.5 (i.e., 0.5≤h1/d2≤2.5), but it is not limited thereto. In one embodiment, the ratio of the first height h1 to the second width d2 may be between 0.7 and 1.5 (i.e., 0.7≤h1/d2≤1.5), but it is not limited thereto. With any of the aforementioned configurations, the ability of the removal element 6 to remove the to-be-removed object 20 can be improved.

In one embodiment, the ratio of the first height h1 to the second height h2 may be between 5 and 25 (i.e., 5≤h1/h2≤25), but it is not limited thereto. In one embodiment, the ratio of the first height h1 to the second height h2 may be between 8 and 20 (i.e., 8≤h1/h2≤20), but it is not limited thereto. With any of the aforementioned configurations, the ability of the removal element 6 to remove the to-be-removed object 20 can be improved.

In one embodiment, the ratio of the first height h1 to the first width d1 may be between 0.35 and 1.5 (i.e., 0.35≤h1/d1≤1.5), but it is not limited thereto. In one embodiment, the ratio of the first height h1 to the first width d1 may be between 0.6 and 1 (i.e., 0.6≤h1/d1≤1), but it is not limited thereto. With any of the aforementioned configurations, the ability of the removal element 6 to remove the to-be-removed object 20 can be improved.

In addition, the constriction portion 632 has an outer wall 632a, wherein, on a projection plane of the front view direction (e.g., front view direction in FIG. 3B), the extension line of the tangent to the outer wall 632a of the constriction portion 632 is defined as the first extension line C1, and the extension line of the tangent of the outer surface 633c of the ring structure 633 is defined as the second extension line C2, where there is a first angle θ1 between the first extension line C1 and the second extension line C2. In one embodiment, the first angle θ1 is between 20 degrees and 80 degrees (i.e., 20°≤θ1≤80°), but it is not limited thereto. In one embodiment, the first angle θ1 is between 40 degrees and 60 degrees (i.e., 40°≤θ1≤60°), but it is not limited thereto. With the aforementioned configuration, the ability of the removal element 6 to remove the to-be-removed object 20 can be improved.

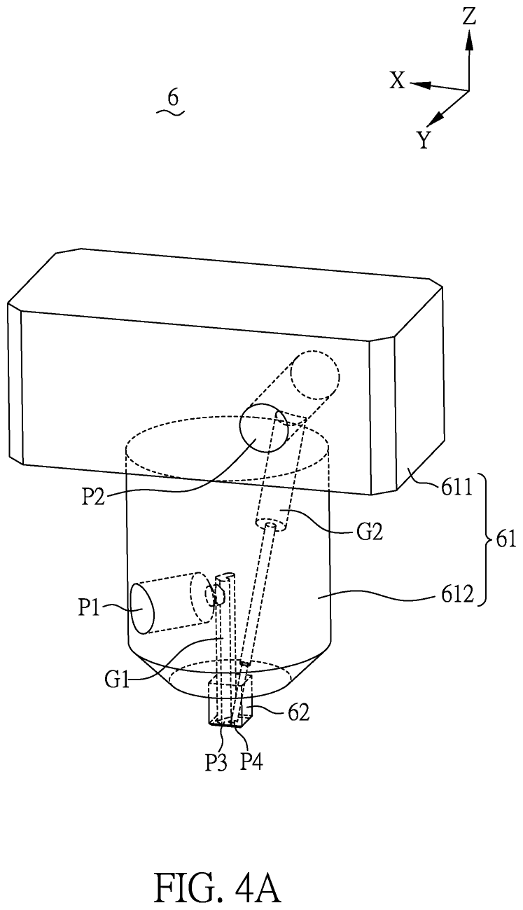

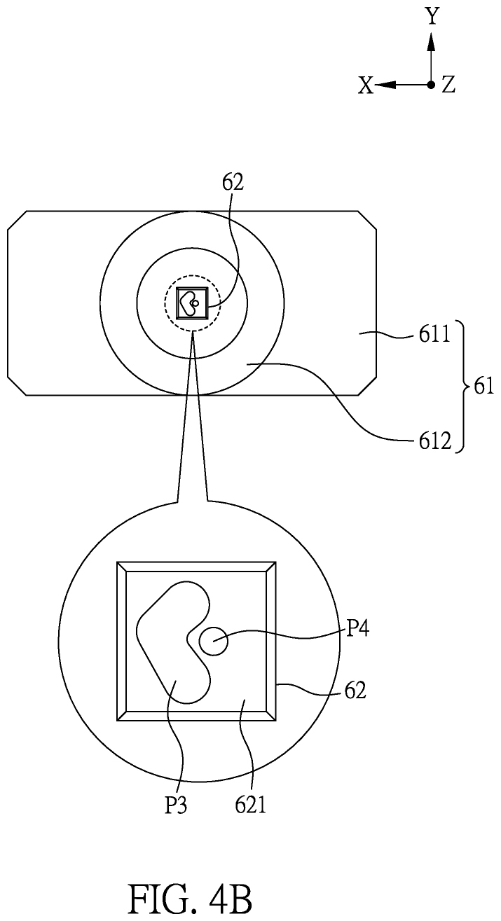

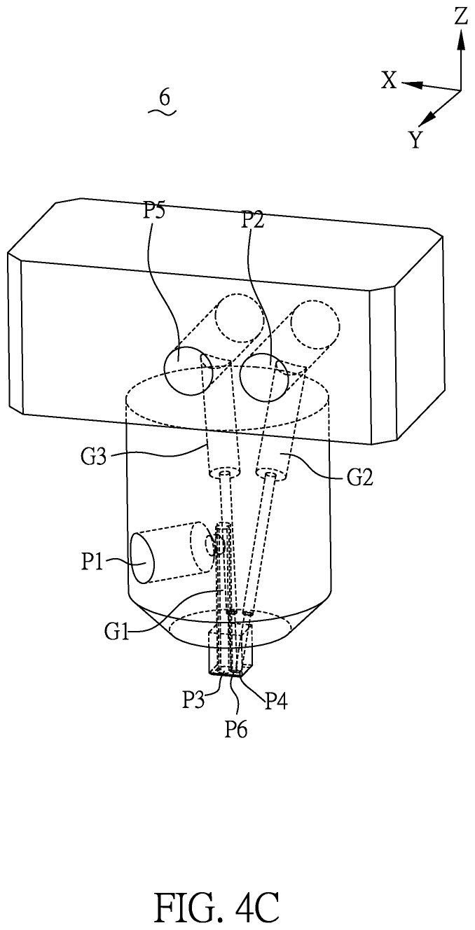

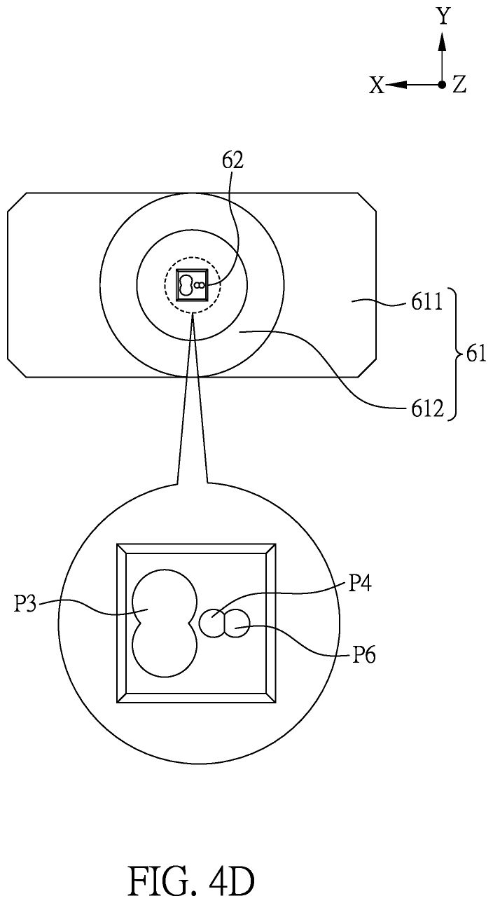

Next, the detailed features of the main body portion 61 and the end portion 62 will be described in detail. FIG. 4A is a schematic diagram of the internal structure of the main body portion 61 and the end portion 62 according to the first embodiment of the present disclosure, FIG. 4B is a bottom view of the main body portion 61 and the end portion 62 according to the first embodiment of the present disclosure, and please also refer to FIGS. 1A to 3B for reference.

As shown in FIG. 4A, the main body portion 61 has a gas extraction through hole P1, and a first gas passage G1 is provided inside the main body portion 61 and, as shown in FIG. 4B, the bottom portion 621 of the end portion 62 has a gas suction through hole P3, wherein the gas extraction through hole P1 and the gas suction through hole P3 may be connected through the first gas passage G1. Therefore, when extracting gas at the gas extraction through hole P1, an airflow (for example, a vacuum airflow) will be formed around the gas suction through hole P3 and in the first gas passage G1, so that the to-be-removed object 20 is drawn into the gas suction through hole P3. In other words, the first gas passage G1 may be, for example, a vacuum gas passage.

As shown in FIGS. 1B, 2, 3A, 4A and 4B, when the elastic portion 63 is jointed to the end portion 62, the gas suction through hole P3 may be exposed through the passage space S3 and the confinement space S2, so that, when the removal element 6 is close to or in contact with the surface of the device under test 2, the to-be-removed object 20 may be confined in the confinement space S2. When extracting gas at the gas extraction through hole P1, the to-be-removed object 20 may be sucked into the first gas passage G1 through the gas suction through hole P3. As a result, the to-be-removed object 20 on the device under test 2 can be removed.

In addition, in one embodiment, the main body portion 61 also has a gas inlet through hole P2, and a second gas passage G2 is provided inside the main body portion 61. As shown in FIG. 4B, the bottom portion 621 of the end portion 62 has a gas ejection through hole P4, wherein the gas inlet through hole P2 and the gas ejection through hole P4 can be connected through the second gas passage G2. Therefore, when applying gas, such as high-pressure gas, to the gas inlet through hole P2, the gas can be ejected from the gas ejection through hole P4. In other words, the second gas passage G2 may be, for example, a high-pressure gas passage.

Moreover, as shown in FIGS. 1B, 2, 3A, 4A and 4B, when the elastic portion 63 is coupled with the end portion 62, the gas ejection through hole P4 may be exposed through the passage space S3 and the confinement space S2, so that, when the removal element 6 is close to or in contact with the surface of the device under test 2, and an airflow is applied to the gas inlet through hole P2, the gas ejection through hole P4 may eject an airflow, so that the to-be-removed object 20 on the device under test 2 is blown up and confined in the confinement space S2. As a result, the to-be-removed object 20 on the device under test 2 can be removed more easily.

In addition, in one embodiment, the gas suction through hole P3 may be larger than, equal to or smaller than the gas ejection through hole P4. In one embodiment, the gas suction through hole P3 may be larger than the gas ejection through hole P4, for example. In addition, in one embodiment, the gas extraction through hole P1, the gas inlet through hole P2, the gas suction through hole P3 or the gas ejection through hole P4 may have various shapes; for example the shape of the gas suction through hole P3 in FIG. 4B is different from that in FIG. 4D, while the present disclosure is not limited. In addition, the first gas passage G1 or the second gas passage G2 may be arranged upright (i.e., parallel to Z direction) or inclined (i.e., not parallel to Z direction), while it is not limited thereto.

The main body portion 61 and the end portion 62 may also have different implementation aspects. FIG. 4C is a schematic diagram of the internal structure of the main body portion 61 and the end portion 62 according to the second embodiment of the present disclosure, FIG. 4D is a bottom view of the main body portion 61 and the end portion 62 according to the second embodiment of the present disclosure, and please also refer to FIGS. 1A to 4B for reference. The embodiment of FIG. 4C is similar to the embodiment of FIG. 4A except that the main body portion 61 of the embodiment of FIG. 4C is further provided with, for example, another gas inlet through hole P5, and another second gas passage G3 is further provided inside the main body portion 61. Moreover, as shown in FIG. 4D, the bottom portion 621 of the end portion 62 is further provided with another gas ejection through hole P6, wherein the another gas inlet through hole P5 and the another gas ejection through hole P6 may be connected through the another second gas passage G3. In addition, as shown in FIG. 4D, in one embodiment, the gas ejection through hole P4 and the another gas ejection through hole P6 may overlap, and the shapes and sizes of the two may be the same or different. Therefore, it can be seen that the main body portion 61 may be provided with a plurality of gas inlet through holes and second gas passages, and the end portion 62 may be provided with a plurality of gas ejection through holes, so that, when removing the to-be-removed object 20, more high-pressure airflows can be provided at the same time to the surface of the device under test 2, so that the to-be-removed object 20 can be removed more easily. In addition, in one embodiment, the main body portion 61 may also be provided with more gas extraction through holes and first gas passages, and the end portion 62 may be provided with more gas inlet through holes, thereby improving the air extraction capability. However, the present disclosure is not limited thereto.

Accordingly, the details of the removal element 6 can be understood.

Next, the details of the working platform 3 will be described. FIG. 5A is a schematic diagram of the working platform 3 according to an embodiment of the present disclosure, FIG. 5B is a schematic diagram of the internal structure of the working platform 3 according to an embodiment of the present disclosure, and please also refer to FIGS. 1 to 4B for reference.

As shown in FIG. 5A, the working platform 3 has a platform surface 31, and the platform surface 31 has a first edge 3a, a second edge 3b, a third edge 3c and a fourth edge 3d. In one embodiment, the working platform 3 may be provided with at least two abutting protrusions (321, 322), such as a first abutting protrusion 321 and a second abutting protrusion 322, which are respectively adjacent to the first edge 3a and the second edge 3b of the platform surface 31. In the vertical direction (e.g., Z direction), at least part of the first abutting protrusion 321 and at least part of the second abutting protrusion 322 may protrude from the platform surface 31. In addition, the working platform 3 may carry a tray 30 on which one or more devices under test 2 may be placed. The tray 30 may be provided with a first side 30a, a second side 30b, a third side 30c and a fourth side 30d. When the tray 30 is placed on the platform surface 31, at least one edge of the tray 30 may contact and lean against at least one abutting protrusion of the working platform 3; for example, the first side 30a and the second side 30b of the tray 30 may contact and lean against the first abutting protrusion 321 and the second abutting protrusion 322, respectively. In one embodiment, the first abutting protrusion 321 may extend along the edge 3a of the platform surface 31, for example, along the edge 3a of the platform surface 31 in a first horizontal direction (e.g., X direction). In one embodiment, the second abutting protrusion 322 may extend along another edge 3b of the platform surface 31, for example, along said another edge 3b of the platform surface 31 in the second horizontal direction (e.g., Y direction).

In addition, the working platform 3 may be provided with a positioning point SD1. In one embodiment, the positioning point SD1 may be arranged at a neighboring position of the first abutting protrusion 321 and the second abutting protrusion 322. In one embodiment, the positioning point SD1 may be provided with a special mark for being identified by the identification unit 4. For example, the positioning point SD1 may be the position of a screw or screw hole, while it is not limited thereto.

In addition, the platform surface 31 may be provided with at least two slots (e.g., 331, 332), and the working platform 3 includes at least two alignment abutting posts (e.g., 341, 342). For example, the platform surface 31 has a first slot 331 and a second slot 332, and the working platform 3 includes a first alignment abutting post 341 and a second alignment abutting post 342. The first alignment abutting post 341 is arranged in the first slot 331 and, in a vertical direction (e.g., Z direction), at least part of the first alignment abutting post 341 protrudes above the platform surface 31 of the working platform 30. The second alignment abutting post 342 is arranged in the second slot 332 and, in the vertical direction (e.g., Z direction), at least part of the second alignment abutting post 342 protrudes above the platform surface 31 of the working platform 30. In addition, the first alignment abutting post 341 may move in the first slot 331, and the second alignment abutting post 342 may move in the second slot 332.

In one embodiment, the platform surface 31 has a diagonal line C3 passing through the positioning point SD1 and the intersection of the third edge 3c and the fourth edge 3d, and the first slot 331 and the second slot 332 may be symmetrically arranged on the platform surface 31. For example, the first slot 331 is disposed on one side of the diagonal line C3 of the platform surface 31, and the second slot 332 is disposed on the other side of the diagonal C3. Moreover, the shortest distance between a center extension line C4 of the first slot 331 and the diagonal line C3 is equal to the shortest distance between a center extension line C5 of the second slot 332 and the diagonal line C3, but it is not limited thereto. In one embodiment, the first slot 331 and the second slot 332 may have the same shape, but not limited thereto. In another embodiment, the first slot 331 and the second slot 332 may also be arranged on the same side of the diagonal line C3 of the platform surface 31 (not shown). However, the present embodiment is not limited thereto.

In addition, in one embodiment, the first edge 3a, the third edge 3c, the first abutting protrusion 321 and the first alignment abutting post 341 may be disposed on one side of the diagonal line C3, and the second edge 3b, the fourth edge 3d, the second abutting protrusion 322 and the second alignment abutting post 342 may be disposed on the other side of the diagonal line C3. In another embodiment, the first abutting protrusion 321 and the second abutting protrusion 322 may also be disposed on the same side of the diagonal line C3 (not shown). However, the present embodiment is not limited thereto.

In addition, there may be a second angle θ2 between a center extension line C4 of the first slot 331 and an edge of the platform surface 31 (e.g., first edge 3a). In one embodiment, the second angle θ2 is between 0 degrees and 90 degrees (i.e., 0°≤θ2≤90°), for example, 45 degrees (i.e., θ2=45°), but it is not limited thereto. In addition, there may be a third angle θ3 between a center extension line C5 of the second slot 332 and an edge of the platform surface 31 (e.g., second edge 3b). In one embodiment, the third angle θ3 is between 0 degrees and 90 degrees (i.e., 0°≤θ3≤90°), for example, 45 degrees (i.e., θ3=45°), but it is not limited thereto. In one embodiment, the second angle θ2 is equal to the third angle θ3 (i.e., θ2=θ3), but it is not limited thereto. In another embodiment, the second angle θ2 may be larger or smaller than the third angle θ3, but it is not limited thereto.

In one embodiment, when the tray 30 is placed on the platform surface 31, the two edges 30a, 30b of the tray 30 may be in contact with the first abutting protrusion 321 and the second abutting protrusion 322, respectively, and the first alignment abutting post 341 and the second alignment abutting post 342 may move to contact the other two edges 30c, 30d of the tray 30, respectively. In one embodiment, the first alignment abutting post 341 and the second alignment abutting post 342 may push the tray 30 toward the first abutting protrusion 321 and the second abutting protrusion 322. As a result, the first tray 30 can be positioned and fixed.

In addition, as shown in FIG. 5A, in one embodiment, the working platform 3 further includes a soft element 37. In one embodiment, the soft element 37 may be imprinted as a mark for positioning. For example, the removal element 6 may imprint the soft element 37, and the imprinted position may be used as a basis for calculating the relative position of the removal element 6 and the positioning point SD1. The soft element 37 may be arranged on the first abutting protrusion 321, the second abutting protrusion 322 or the platform surface 31 without affecting the placement, abutting and fixing of the tray 30.

As shown in FIG. 5B, the working platform 3 may be provided with an air cylinder apparatus 35 and a third sliding rail structure 36. The air cylinder apparatus 35 may include a first air intake hole 351, a second air intake hole 352 and a displacement mechanism 353, wherein the first alignment abutting post 341 and the second alignment abutting post 342 are arranged on the displacement mechanism 353, and the displacement mechanism 353 has a moving portion 353a arranged on the third sliding rail structure 36, so that the displacement mechanism 353 may move in the extension direction of the third sliding rail structure 36 by the third sliding rail structure 36. In one embodiment, when gas enters the first air intake hole 351, the displacement mechanism 353 moves in a direction toward the second air intake hole 352 and, when gas enters the second air intake hole 352, the displacement mechanism 353 moves toward a direction of the first air intake hole 351. Therefore, with the operation of the air cylinder apparatus 35, the first alignment abutting post 341 and the second alignment abutting post 342 may also be driven to move. It is noted that, although the embodiment of FIG. 5 uses the air cylinder apparatus 35 to drive the first alignment abutting post 341 and the second alignment abutting post 342 to move, in other embodiments, other methods may also be used, such as the first alignment abutting post 341 and the second alignment abutting post 342 being moved by means of mechanical apparatuses, wherein the operation of the mechanical apparatuses may be performed by, for example, motors, gears, etc., but it is not limited thereto. In addition, in one embodiment, the working platform 3 may be provided with a sensing element 38 for sensing whether an object is placed on the platform surface 31, thereby determining whether to activate the air cylinder apparatus 35 to place the object by abutting, but it is not limited thereto. In one embodiment, the sensing element 38 may be, for example, a pressure sensing element or an optical sensing element, while it is not limited thereto.

Accordingly, the details of the working platform 3 can be understood.

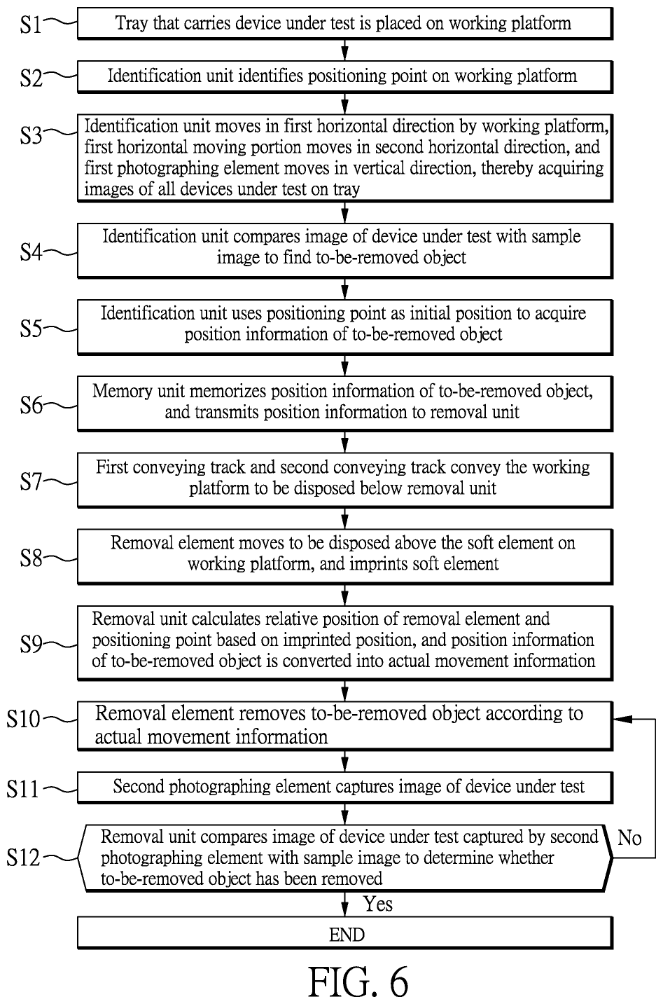

Next, the operation of the electronic device 1 will be described. FIG. 6 is a flow chart illustrating the operation of the electronic device 1 according to an embodiment of the present disclosure, and please also refer to FIGS. 1A to 5B for reference at the same time.

First, step S1 is performed, in which the tray 30 carrying the device under test 2 is placed on the working platform 30, the working platform 30 may move to be disposed below the identification unit 4 (or the starting position of the working platform 30 is directly disposed below the identification unit 4) by the first conveying track 44, and the first photographing element 8 of the identification unit 4 faces the platform surface 31.

Then, step S2 is executed, in which the identification unit 4 identifies the positioning point SD1 on the working platform 3.

Then, step S3 is executed, in which the identification unit 4 moves in the first horizontal direction (e.g., X direction) by the working platform 3, the first horizontal moving portion 41 moves in the second horizontal direction (e.g., Y direction), and the first photographing element 8 moves in the vertical direction (e.g., Z direction), so that the first photographing element 8 may face different positions of the tray 30, thereby acquiring images of all the devices under test 2 on the tray 30.

Then, step S4 is executed, in which the identification unit 4 compares the image of the device under test 2 with the sample image to find the to-be-removed object 20 on the device under test 2.

Then, step S5 is executed, in which the identification unit 4 uses the positioning point SD1 as the initial position to calculate the relative position of each to-be-removed object 20, thereby acquiring the position information of the to-be-removed object 20. In one embodiment, the position information may be, for example, coordinate information, wherein the positioning point SD1 may be used as the origin, but it is not limited thereto. The aforementioned calculation may be performed by the first processing unit 72, but it is not limited thereto.

Then, step S6 is executed, in which the memory unit 7 memorizes the position information of the to-be-removed object 20, and transmits the position information to the removal unit 5.

Then, step S7 is executed, in which the first conveying track 44 and the second conveying track 54 convey the working platform 3 to be disposed below the removal unit 5.

Then, step S8 is executed, in which the removal element 6 moves to be disposed above the soft element 37 on the working platform 30, and imprints the soft element 37.

Then, step S9 is executed, in which the second photographing element 9 obtains the imprinted position, the removal unit 5 calculates the relative position of the removal element 6 and the positioning point SD1 based on the imprinted position, and the position information of the to-be-removed object 20 is converted into actual movement information according to the relative position of the removal element 6 and the positioning point SD1. In one embodiment, the removal unit 5 may perform the aforementioned calculation through the second processing unit 73, but it is not limited thereto.

Then, step S10 is executed, in which the removal element 6 moves according to the actual movement information, and the second conveying track 54 moves the working platform 3 according to the actual movement information, so that the removal element 6 removes the to-be-removed object 20 on the device under test 2.

Then, step S11 is executed, in which the second photographing element 9 captures an image of the device under test 2.

Finally, step S12 is executed, in which the removal unit 5 compares the image of the device under test 2 captured by the second photographing element 9 with the sample image (or the image of the device under test 2 captured by the first photographing element 8) so as to determine whether the to-be-removed object 20 has been removed or not. If it has been removed, the process ends; otherwise, step S10 executed again. The aforementioned comparison may be performed by the second processing unit 73, but it is not limited thereto. In another embodiment, steps S11 and S12 may not be executed.

The aforementioned steps are only examples, and as long as it is reasonable, the order between the steps may be adjusted according to the needs, or the aforementioned steps may be increased or decreased according to the needs.

Accordingly, the operation of the electronic device 1 can be understood.

In one embodiment, the present disclosure may at least compare the presence or absence of components in the electronic device 1 and/or the configuration of the components as evidence for whether the object falls within the scope of patent protection, but it is not limited thereto.

As a result, the present disclosure provides an improved electronic device that can accurately remove the to-be-removed object on the device under test. Alternatively, the electronic device may remove the to-be-removed object more easily in comparison with the prior art.

The features of the various embodiments of the present disclosure may be arbitrarily mixed and matched as long as they do not violate the spirit of the disclosure or conflict with each other.

The aforementioned specific embodiments should be construed as merely illustrative, and not limiting the rest of the present disclosure in any way.

What is claimed is:

1. An electronic device for removing a to-be-removed object from a device under test, comprising:
a working platform for carrying the device under test;
an identification unit arranged above the working platform for acquiring position information of the to-be-removed object; and
a removal unit coupled to the identification unit, and provided with a removal element for removing the to-be-removed object based on the position information,
wherein the removal element has a ring structure and a confinement space connected with the ring structure, and the confinement space faces the working platform.

2. The electronic device as claimed in claim 1, wherein the electronic device further comprises a memory unit coupled to the identification unit for memorizing the position information of the to-be-removed object.

3. The electronic device as claimed in claim 2, wherein the identification unit includes a first photographing element coupled to the memory unit.

4. The electronic device as claimed in claim 1, wherein the removal element includes a main body portion and an end portion coupled to the main body portion.

5. The electronic device as claimed in claim 4, wherein the main body portion is provided with a gas extraction through hole, and the end portion has a gas suction through hole, wherein the gas extraction through hole and the gas suction through hole are connected through a first gas passage.

6. The electronic device as claimed in claim 5, wherein the main body portion is provided with a gas inlet through hole, and the end portion has a gas ejection through hole, wherein the gas inlet through hole and the gas ejection through hole are connected through a second gas passage.

7. The electronic device as claimed in claim 4, wherein the removal element further includes a joint portion coupled to the end portion.

8. The electronic device as claimed in claim 1, wherein the removal unit further includes a second photographing element coupled to the memory unit.

9. The electronic device as claimed in claim 1, wherein the working platform includes a platform surface, at least two abutting protrusions and at least two alignment abutting posts, and the platform surface includes a first edge, a second edge, a third edge and a fourth edge, in which one of the at least two abutting protrusions extends along the first edge in a first direction, and the other one of the at least two abutting protrusion portions extends along the second edge in a second direction different from the first direction.

10. The electronic device as claimed in claim 1, wherein the electronic device moves the device under test from a projection position of the identification unit on the working platform in a normal direction to a projection position of the removal unit on the working platform in the normal direction via at least one conveying track or a robotic arm.

11. The electronic device of claim 3, wherein the identification unit 4 further includes a first vertical moving portion and a first horizontal moving portion, the first photographing element and the first horizontal moving portion are connected in a vertical direction through the first vertical moving portion, the first vertical moving portion is arranged on a first vertical sliding rail of the first horizontal moving portion, and the first photographing element is connected with the first horizontal moving portion.

12. The electronic device as claimed in claim 11, wherein the first horizontal moving portion is arranged to be connected to a hanging portion of a first fixing base, and the hanging portion is provided with a first sliding rail structure extending along a horizontal direction.

13. The electronic device as claimed in claim 8, wherein the removal unit further includes a second horizontal moving portion, a connecting portion and a second vertical moving portion, the connecting portion has a second vertical sliding rail and a third vertical sliding rail respectively extending along the vertical direction, the connecting portion is connected with the second horizontal moving portion, the second photographing element is connected with the connecting portion through the second vertical sliding rail, the second vertical moving portion is connected with the connecting portion through the third vertical sliding rail, and the removal element is connected with the second vertical moving portion in a vertical direction.

14. The electronic device as claimed in claim 13, wherein the second horizontal moving portion is arranged to be connected with a hanging portion of a second fixing base, and the hanging portion has a second sliding rail structure on which the second horizontal moving portion is disposed.

15. The electronic device as claimed in claim 13, wherein the identification unit and the removal unit are integrated into one unit sharing one photographing element.

16. The electronic device as claimed in claim 4, wherein the removal element further includes a constriction portion and a ring structure, the constriction portion is connected between the joint portion and the ring structure, and one end of the constriction portion adjacent to the joint portion gradually narrows toward the other end adjacent to the ring structure in the vertical direction.

17. The electronic device as claimed in claim 6, wherein the main body portion is provided with an additional gas inlet through hole, the end portion is provided with an additional gas ejection through hole, and the additional gas inlet through hole is connected to the additional gas ejection through hole through an additional second gas passage.

18. The electronic device as claimed in claim 17, wherein the gas ejection through hole overlaps with the additional gas ejection through hole.

19. The electronic device as claimed in claim 9, wherein the platform surface is provided with at least two slots), and the at least two alignment abutting posts move in the at least two slots, respectively.

20. The electronic device as claimed in claim 19, wherein the working platform carries a tray having two edges in contact with the at least two abutting protrusions, respectively, and the at least two alignment abutting posts move to contact another two edges of the tray, respectively.
